(19) United States
(12) Patent Application Publication
(10) Pub. No.: US 2005/0189176 A1
(43) Pub. Date: Sep. 1, 2005

(54) Safety harness with removable outer shell

(76) Inventors: Gerald DeMeyer, Rochester, MI (US); Patrick J. Gorman, White Lake, MI (US)

Correspondence Address: HARNESS, DICKEY & PIERCE, P.L.C., P.O. BOX 828, BLOOMFIELD HILLS, MI, 48303, US

(21) Appl. No.: 11/055,542

(22) Filed: Feb. 10, 2005

Related U.S. Application Data
(60) Provisional application No. 60/543,479, filed on Feb. 10, 2004.

(51) Int. Cl. A62B 35/00

(52) U.S. Cl. 182/231

(57) ABSTRACT

A harness for a hunter is provided having a tree mounting assembly. The tree mounting assembly includes a retractor configured to arrest the fall of a user. The retractor contains about 20 feet of webbing and is configured to actuate to locked webbing when the webbing is paying out at a rate indicative of slightly greater than about 0.5 g acceleration being applied to the user coupled to the webbing.

### CROSS-REFERENCE TO RELATED APPLICATIONS

This application claims the benefit of U.S. Provisional Application No. 60/543,479, filed on Feb. 10, 2004. The disclosure of the above application is incorporated herein by reference.

### FIELD OF THE INVENTION

The present invention relates to a safety harness and, more particularly, to a safety harness for use during hunting to reduce injuries to the hunters due to accidental falls from a tree stand.

### BACKGROUND AND SUMMARY OF THE INVENTION

Hunting stands are frequently used by hunters and commonly referred to as hunting blinds, tree stands, tree-mounted hunting stands, and the like. The hunting stands can take many forms; some exemplary forms include tree-mounted stands, ground-based stands, and self-supported hunting stands. Further tree stands offer various amenities contained within the stand; some exemplary amenities include seats, various stand adjustments, and mounting and storage locations for rifles, equipment and the like.

Many devices have been developed to secure the hunter in a hunting stand to improve hunter safety. As such, many devices address the scenario where the hunter installs the hunting stand above the ground. Examples of such installations include securing the hunting stand to a tree or constructing a self-supporting assembly to maintain the hunting stand above the ground. In the above examples, there is an important concern about the hunter falling from the tree stand to the ground. It is desirable to have a system allowing the hunter generally complete freedom of movement while in the tree stand. It is also desirable to provide a device that keeps the hunter safe if the hunter were to fall from the tree stand. Any safety harness must address and balance the competing interests of freedom of motion and safety during a fall. It has been suggested that seat belt retractors with associated webbing can be used to restrain a hunter. An example of one of these designs can be seen in US Patent Application No. 2004/0140158 herein incorporated by reference.

As the amount of webbing increases about a spool of the retractors of the prior art, the diameter of the wound webbing increases. As acceleration of the spool is a function of the diameter of the wound webbing, it is not possible to have a retractor with more than about 6 to 8 feet which will function to stop a falling hunter at between 0.5 g and 1.0 g. Should more than about 6 to 8 feet of webbing be used, even slow extractions of the webbing will lock the spool.

To overcome the disadvantages of the prior art, a harness is provided having a tree mounting assembly. The tree mounting assembly includes a retractor configured to arrest the fall of a user. The retractor contains about 20 feet of webbing and is configured to actuate to locked webbing when the webbing is paying out at an acceleration of greater than 0.5 g being applied to the user coupled to the webbing.

In another embodiment to the invention, a systems which incorporates a removable combination of clothing with integrated climbing belt for fall arresting and rescue from confined spaces is provided. The system provides the advantages of ease of use, and utilizes a harness which distributes loads to a wide and strategic areas of the body that are more capable of sustaining high loads for a short period of time.

The harness has a climbing belt permanently stitched to one side of the harness and a D-Ring sewn to the other side of the harness capable of receiving the climbing belt's connecting hardware i.e., carbiner, snap hook, etc. The climbing belt is used during climbing, either up a utility pole of while climbing up a tree to a tree stand. The full body fall arrest harness has snaps imbedded and properly positioned in it to securely attach to the garment receiving the harness. The garment, in turn, has the receiving snaps also positioned to properly locate the harness into the garment. The use of snaps allow the user to remove the harness from the garment for cleaning or for the use in another type garment i.e., camouflage garment to an orange garment, reflective garment instead of a non-reflective garment, etc. The fully body arrest harness may be attached to various articles of clothing such as a jacket, vest, overalls or coveralls so that donning the article of clothing and harness is easy and automatically positions the harness for proper and safe use. The harness may be used for industrial purposes or recreational purposes, such as hunting from a tree stand.

One of the major issues in proper use of a fall arrest harness is the proper installation to a user's body of the fall arrest harness. Many potential product users become confused with how to properly put on the fall arrest harness and do not properly install the harness to their body. This has the potential to expose them to the risk of more severe injuries or even death in the event of a fall. One potential method to make it easier for the user to understand how to properly install their harness is to package the product on a hanger or harness caddie. The caddie may be in the outline or shape of a human with the harness draped around it showing the proper way a person should wear the harness. This visual presentation will make it easy for the person to see how to put it on right. Another additional way to help clarify how to put the harness on properly is to place small identifying tags to key locations on the harness. The tags might be used for locations such as right shoulder, left shoulder, right chest, left chest, left leg inside, left leg outside, right leg inside, right leg outside, attaching tether and tree strap to name just a few possible locations to be identified. The tags would be especially helpful if the harness were not stored on the caddie, i.e. just thrown in a pile which does frequently occur. The tags can be of many different possible materials (possibly Tyvek or similar material) that will withstand a lifetime of use and remain attached and readable.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 is an assembled view of the safety harness of the present invention;

FIG. 2 is the safety harness of FIG. 1 coupled to a vest;

FIG. 3 represents a safety harness vest assembly of FIG. 2 in a closed configuration;

FIGS. 4 and 5 represent a retractor assembly for a fixation to a tree or tree stand which is fixed to the harness vest assembly; and

FIG. 6 is a diagrammatic view of a safety harness constructed in accordance with the teachings of the present invention diagrammatically showing the hunter's safety harness for a tree stand.

### DETAILED DESCRIPTION OF THE PREFERRED EMBODIMENTS

The following description of the preferred embodiments is merely exemplary in nature and is in no way intended to limit the invention, its application, or uses.

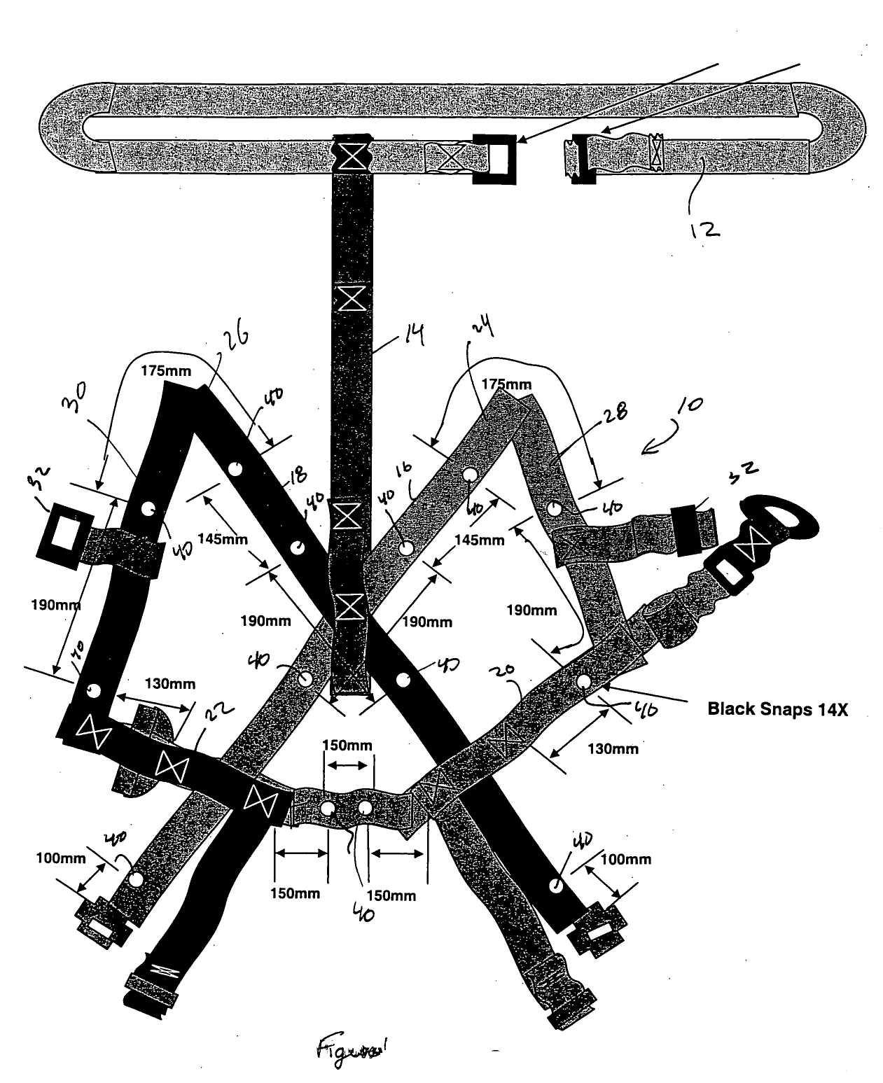

FIG. 1 shows the harness 10 which is configured to be coupled to a tree restraining belt 12. The harness 10 is formed of a vertical belt portion 14 and a cross pair of back supporting straps 16 and 18. To provide adjustment, a pair of waist surrounding webbing portions 20 and 22 are slidably coupled to the first pair of back supporting straps 16 and 18. Coupled between the waist surrounding webbing portions 20 and 22 and a first end 24 and 26 of the crossed back support straps 16 and 18 is a pair of chest restraining belts 28 and 30.

Coupled to the ends of the belt is a plurality of buckles 32 which are configured to adjustably fasten the harness 10 about a user's torso (not shown). Additionally coupled to a substantial amount of the webbing of the harness 10 is a plurality of fasteners 40 which is configured to couple the harness 10 to a fabric vest 44. These fasteners can, for example, be of the form of snaps, buttons or fabric hook-type fasteners such as Velcro. These fasteners 40 are configured to engage to corresponding fasteners 42 on the vest 44.

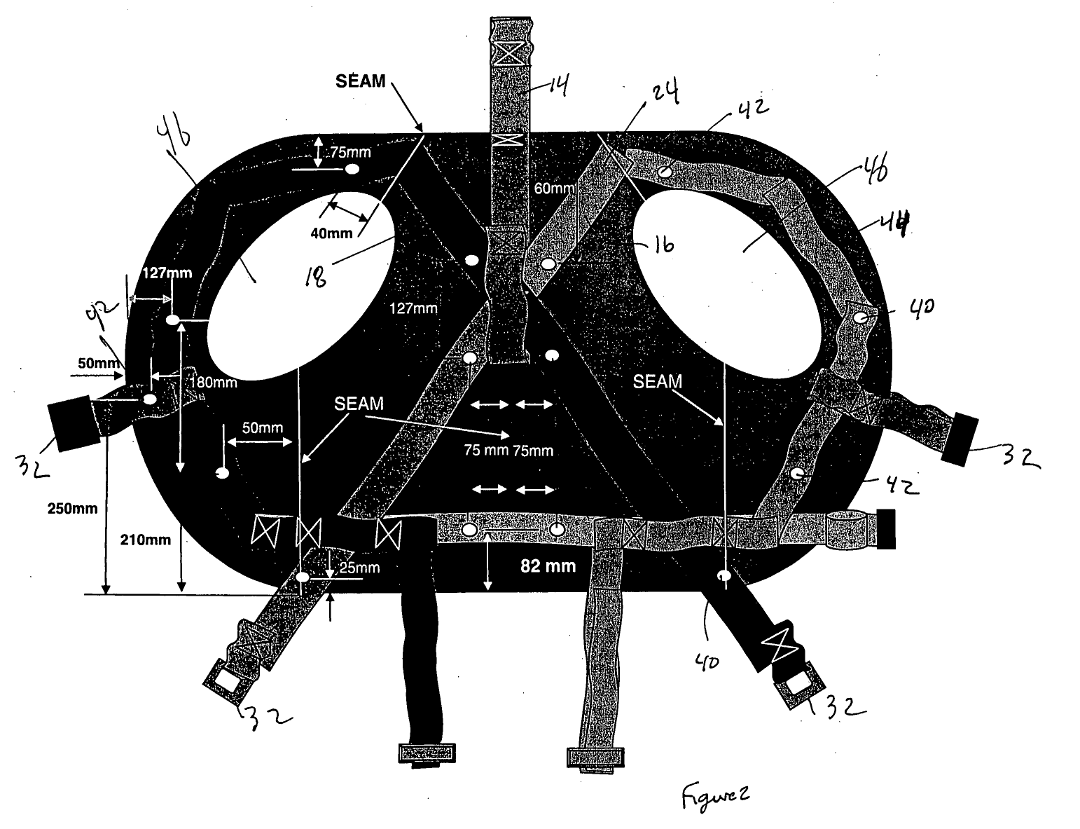

As best seen in FIG. 2, the vest 44 is laid in an open configuration. The harness 10 is then spread out on top of the vest and is coupled to the vest using the fasteners 40 and 42. Further, the vest 44 is shown as an oval having a pair of arm receiving apertures 46. It is envisioned that the vest 44 can take the form of a jacket having sleeves. Furthermore, the vest 44 can be a simple cloth vest having patterns such as camouflage or hunters orange, it is further envisioned that the vest can be insulated or rain resistant.

The cross pair of back supports are formed of a first and second cross back support webbing members 16 and 18. Both of these members 16 and 18 have fasteners 40 located at central positions of the members 16 and 18. Located between the pair of waist support portions 20 and 22 and the first and second cross back support webbing members 16 and 18 are fasteners 40.

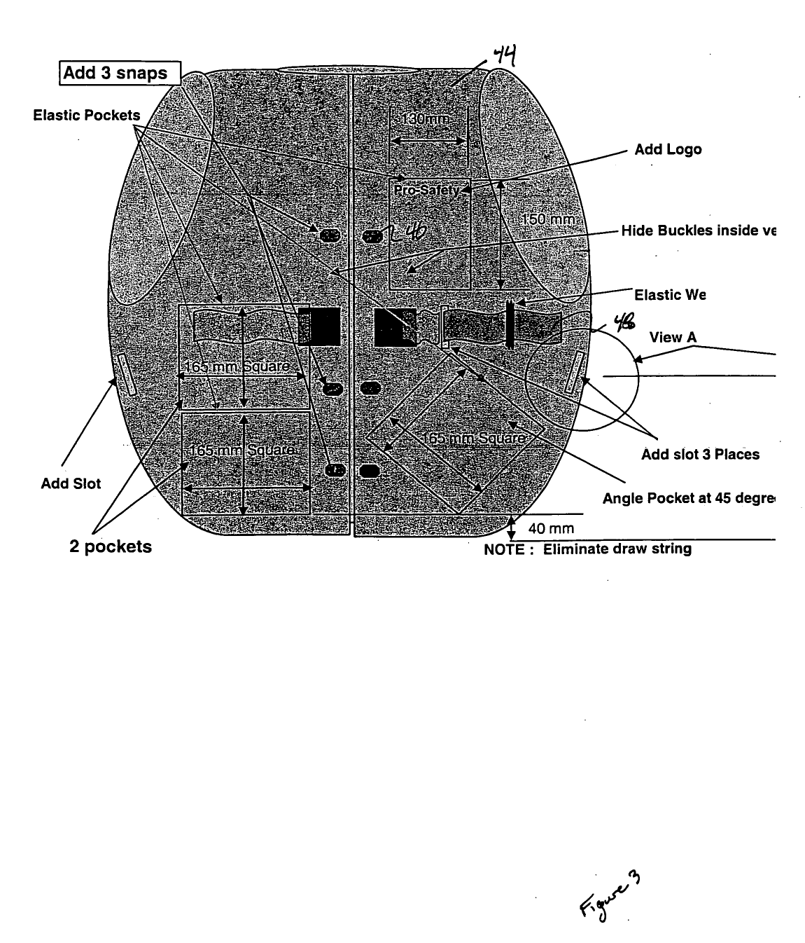

Further as shown in FIG. 3, the exterior of the vest 44 can have a plurality of snaps or a fastener 46 or belts 48 which are used to enclose the vest about the user's torso when in use. In this regard the fastener 40 can be formed of a male snap 41 coupled to the webbing 16, 18, 20, 22, and 28. Additionally, the female fastener portions are placed on the interior surface of the vest 40.

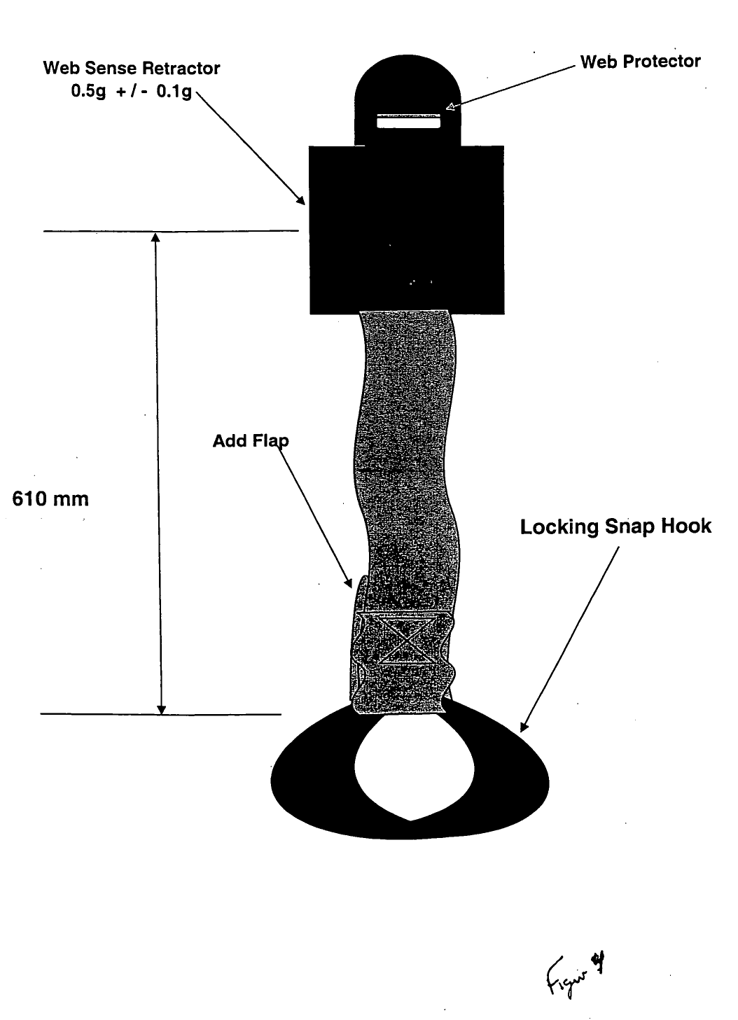

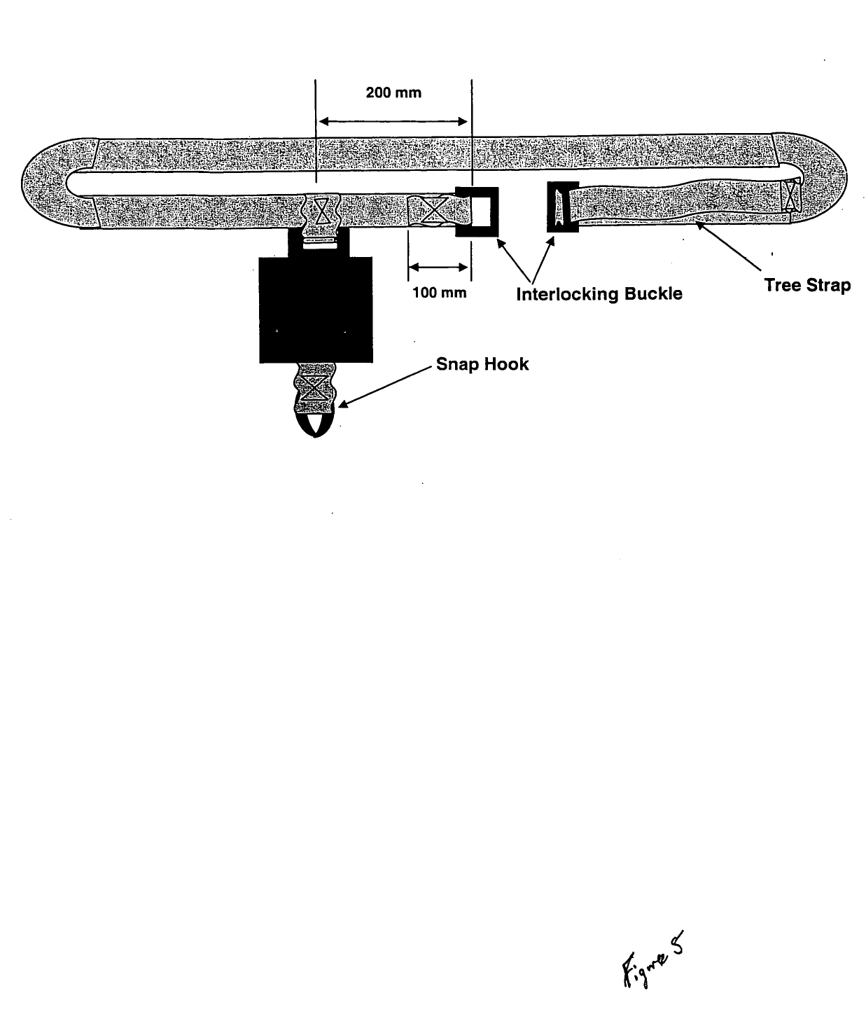

FIGS. 4 and 5 depict views of a retractor with a snap hook assembly and a retractor with a tree strap assembly which is used to couple the harness 10 and the vest 44 to the tree. The retractor is configured to hold more than 18 feet of webbing and, more particularly, more than about 20 feet of webbing. The retractor has a web sense mechanism which actuates when the webbing is subjected to a predetermined amount of acceleration, namely between 0.5 g and 1.5 g.

In the preferred embodiment, the retractor utilizes a webbing having a thickness of less than about 0.75 mm and, particularly, less than about 0.6 mm. This thickness allows for more than 20 feet of webbing to be wound about the spool. Further, this thickness of webbing allows the web sense mechanism for the retractor to function properly throughout the entire extraction of the webbing.

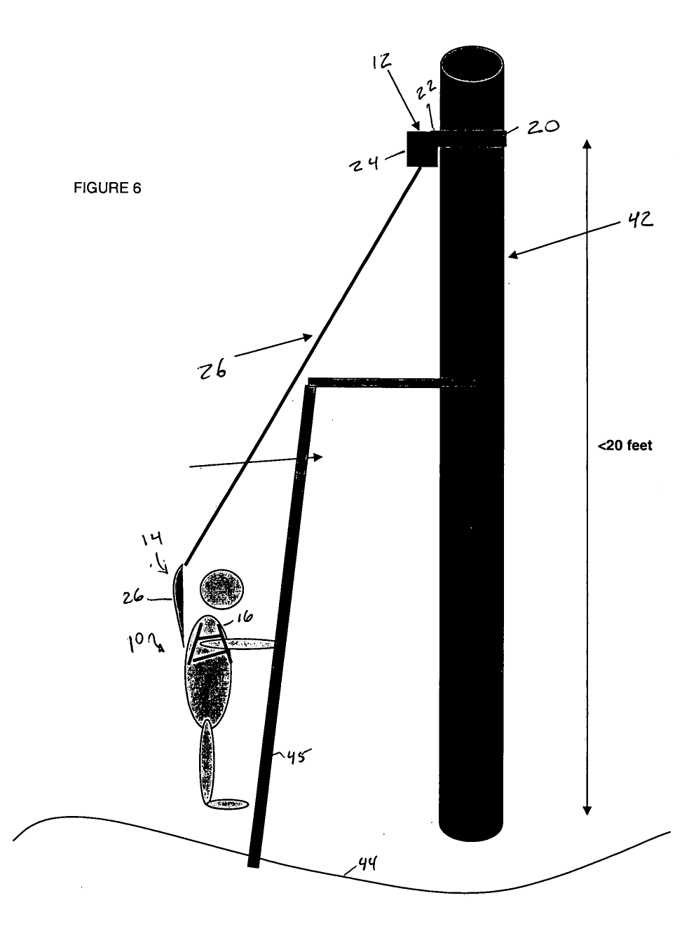

Referring to FIG. 6, there is shown an exemplary safety harness in accordance with a preferred embodiment of the present invention and generally indicated by reference numeral 10. The safety harness 10 includes a tree mounting assembly 12, a linking assembly 14, and a body harness 16. The tree mounting assembly 12 comprises a cinching clamp, a tree loop 20, and a mounting bracket 22. The linking assembly 14, which is configured to couple to the tree mounting assembly 12, comprises a retractor 24, a belt 26, and a connector 28. The body harness 16 (typically provided in conjunction with a wearable garment such as a jacket or vest 70), which is configured to be coupled to the linking assembly 14 and the tree mounting assembly 12, comprises an adjustable waist belt 30, an adjustable belt lock 32 such as a buckle or buckle and mating tongue, and a tether line 34.

In a preferred embodiment of the present invention, the tree mounting assembly 12 may be removably secured to a tree 42 at a predetermined distance above the ground 44, typically proximate the location of a tree stand 45. The mounting bracket 22 and the tree loop 20 are positioned around the tree 42 and then secured with the cinching clamp 18, which allows the hunter to tighten the mounting assembly 12 against the tree 42. Tightening the tree loop 20 and the mounting bracket 22 against the tree provides a stable and a secure location to which the linking assembly 14 can be attached.

The mounting assembly 12 is installed by the hunter 46 around the tree 42 so the mounting bracket 22 is accessible to the hunter 46, while in the hunting stand 45. Once the hunter 46 has installed the mounting assembly 12 to the tree 42, the hunter will connect the linking assembly 14, and more particularly the retractor 24, to the mounting assembly 12. The lengthened webbing or belt 26 allows the hunter to climb down the tree stand and still be protected by the retractor.

The linking assembly 14 comprises the retractor 24, the belt 26, and the connector 28. The retractor 24 is a modified emergency locking (ELR) seat belt retractor having a retractor frame with a keyhole opening or slot. As is known in the art, seat belt retractor 24 includes a cylindrical belt reel or spool rotatably mounted on bearing or bushings to the retractor frame for coiling and uncoiling the belt 26. The spool or reel is stopped by a lock mechanism. In the present application, the lock mechanism comprises an inertia sensor such as a web sensor, a lock pawl (or lock bar or lock dog), which is brought into contact with teeth on a lock wheel associated with the reel. The belt reel is spring loaded, in a belt rewind direction, by a rewind spring (not shown).

One skilled in the art will readily appreciate many seat belt retractor devices can be used in the present invention. One will further appreciate the application of a seat belt retractor in the present invention does not necessitate the use of a vehicle deceleration sensor commonly found in seat belt retractors. Nevertheless, a modified seat belt web sensor is necessary for the proper operation of the present invention. One such exemplary seat belt retractor is shown in U.S. Pat. No. 6,283,391, which is commonly assigned and hereby incorporated by reference in its entirety as if fully set forth herein. The web sensor mechanism within the retractor will initiate the locking-up of the retractor when the belt 60 is being unwound (protracted) from the spool at a level (rate or acceleration) in excess of a predetermined level. This rapid unwinding of the spool would occur as the hunter starts to fall or falls from the tree stand. In the present invention the web sensor mechanism is set to initiate the locking up of the reel 60 when the belt 26 is unwound therefrom at an acceleration at or above about 0.5 g-1.5 g. The typical web sensor of an automotive seat belt retractor will initiate the locking up of the retractor at or above 1.5 g. Preferably, more than 18 feet and, most preferably, more than 20 feet of webbing will be placed on the spool.

The description of the invention is merely exemplary in nature and, thus, variations that do not depart from the gist of the invention are intended to be within the scope of the invention. Such variations are not to be regarded as a departure from the spirit and scope of the invention.

1. An apparatus to secure a user thereof to an elevated perch, comprising:
a safety harness assembly wearable by the user, the assembly having a lockable retractor having more than 18 feet of webbing, a body harness and a belt extending therebetween, wherein the retractor is configured to become locked to prevent extension of the belt from the retractor in response to acceleration of the user at greater than 0.5 g.

2. The apparatus as defined in claim 1 wherein the retractor is configured to be removably secured to a support proximate the perch and adapted to improve the safety of the user while in the perch.

3. The apparatus as defined in claim 1 wherein the body harness is releasably secured to the retractor.

4. The apparatus as defined in claim 1 wherein the body harness includes a plurality of fasteners configured to be coupled to a corresponding set of fasteners on a vest.

5. The apparatus as defined in claim 4 wherein the fasteners are one of snap, VELCRO™, or buttons.

6. The apparatus as defined in claim 1 wherein the retractor comprises webbing having a thickness of less than 0.7 mm.

7. The apparatus as defined in claim 1 wherein the retractor is configured to be locked to prevent extension of the belt in response to the belt being accelerated between 1.5 g and 0.5 g.

8. The apparatus as defined in claim 1 wherein the belt retractor includes an inertia sensor for initiating lock-up of the retractor.

9. The apparatus as defined in claim 8 wherein the inertia sensor is set to initiate lock-up of the retractor as the belt is withdrawn from the retractor at a determinable rate or acceleration.

10. The apparatus as defined in claim 1 wherein the elevated perch is a tree-mounted stand and the user is a hunter using the stand.

11. An apparatus to secure a hunter to a tree while in a tree-mounted hunting stand comprising:
a mounting assembly having one of a cinching clamp, a tree loop, a mounting bracket, and combinations thereof;
a linking assembly having one of a retractor, a connector, a belt, and combinations thereof;
a body harness having one of a waist belt, a buckle, leg leads, knee loops, shoulder straps, and combinations thereof, said body harness having a plurality of first fasteners;
a vest having a plurality of second fasteners configured to couple to the first fasteners;
the mounting assembly configured to be removably secured to the tree and to the linking assembly, wherein the linking assembly is configured to be removably secured to the mounting assembly and to the body harness, wherein the body harness is worn by the hunter.

12. The apparatus as defined in claim 11 wherein the mounting assembly comprises a retractor configured to be removably secured to a support proximate the perch and adapted to improve the safety of the user while exiting the perch.

13. The apparatus as defined in claim 11 wherein the body harness is releasably secured to the retractor.

14. The apparatus as defined in claim 11 wherein the first plurality of fasteners is buttons.

15. The apparatus as defined in claim 4 wherein the first plurality of fasteners one of a snap, VELCRO™, or button.

16. The apparatus as defined in claim 12 wherein the retractor comprises webbing having a thickness of less than 0.7 mm.

17. The apparatus as defined in claim 12 wherein the retractor is configured to be locked to prevent extension of the belt in response to the belt being accelerated between 1.5 g and 0.5 g.

18. The apparatus as defined in claim 11 wherein the belt retractor includes an inertia sensor for initiating lock-up of the retractor.

19. The apparatus as defined in claim 18 wherein the inertia sensor is set to initiate lock-up of the retractor as the belt is withdrawn from the retractor at a determinable rate or acceleration.

20. The apparatus as defined in claim 11 wherein the elevated perch is a tree-mounted stand and the user is a hunter using the stand.
